(19) United States
(12) Patent Application Publication
(10) Pub. No.: US 2018/0365463 A1
(43) Pub. Date: Dec. 20, 2018

(54) QR (DATAMATRIX) CODED MULTIPLE INFORMATION SYSTEM

(71) Applicant: KKB-KREDI KAYIT BUROSU ANONIM SIRKETI, Istanbul (TR)

(72) Inventors: Kasim AKDENIZ, Istanbul (TR); Koray KAYA, Istanbul (TR); Abdullah BILGIN, Istanbul (TR); Ali Kemal CENK, Istanbul (TR); Inci KESICI, Istanbul (TR)

(21) Appl. No.: 16/061,260

(22) PCT Filed: Dec. 2, 2016
(86) PCT No.: PCT/TR2016/050483

§ 371 Date: Jun. 11, 2018

(30) Foreign Application Priority Data
Dec. 9, 2015 (TR) 2015/15800

(51) Int. Cl. G06K 7/14; G06K 19/06

(52) U.S. Cl. CPC G06K 7/1417; G06K 19/06037

(57) ABSTRACT

Invention is QR (Datamatrix) coded multi information system that is developed for user (10) to benefit from campaign/discount at application area and includes respectively; -QR code (Datamatrix) in which desired multi information takes part, -Plastic card on which QR code (Datamatrix) is printed, -Handheld terminal, mobile application or barcode scanner for reading QR code (Datamatrix) at application area. Application aims to make multi information be accessible with a single card by integrating QR code (Datamatrix) with a plastic portable card.

### TECHNICAL AREA

Invention is concerned with an application giving access to multi information of user, using QR (Datamatrix) code technology, by reading relevant QR code with handheld terminal or barcode scanner over the card applied.

Invention aims to make multi information be accessible with a single card by integrating QR code with a plastic portable card.

### CURRENT SITUATION OF THE TECHNIC

Enterprises, nowadays, make some discounts and campaigns at times not to lose their customer. Customers prefer to go to stores if they want to take advantage of these discounts and campaigns.

Now, enterprises offer their customers magnetic cards to make them take advantage of the discounts and campaigns with intent to satisfy them. Customers benefit from the opportunities with the numbers specific to them given through these cards. However, customers are asked for information as identification number, e-mail, telephone number etc. at the initial stage during registration for preparing these cards. This case gives rise to waste of time for both customer and store manager. Also customers get bored of this condition.

According to literature search, similar applications were encountered, concerning QR code applications, as follows.

TR 2013/01567 numbered patent application is concerned with, by integrating with sale systems of enterprises or through the instrument of a handheld terminal or mobile device for enterprises without sale system, QR coded loyalty system which is a customer monitoring system without card and rewards customers in line with amount and frequency of shopping of a customer and distribution of Findeks Credit Rating of a customer. The loyalty system includes, as well as handheld terminal, a central server which makes calculations required for prize gaining/using and in where records of prize gaining/using are kept, a QR code formation module which enables to create a QR code representing shopping information and to print on the shopping receipt and an intelligent mobile device that a mobile application may be loaded which enables QR code to be read, information within to be conveyed to said central server and user to make request to central server for using prizes. As is seen, examining the current structure heedfully, it is obvious that a structure is not available which may offer solutions to the disadvantages in question.

TR2012/00991 numbered patent application, another application as a result of technical researches, is concerned with mobile payment platform that is integrated with QR (Datamatrix) based banking systems, containing a mobile payment platform by using QR code technology. Yet, there is no sign of any structuring that may offer solutions to the disadvantages specified above.

Finally, advancement is required in relevant technical field due to problems mentioned above and inefficacy of current solutions to these problems.

### AIM OF INVENTION

The system, which was created by inspiring of current state, aims to solve the problems mentioned above.

The invention is an application which enables accession to multi information of users and also holder of the card to benefit from various discount/gift/campaigns by reading a single datamatrix, which will be printed on plastic card that is used as payment instrument as credit card, meal card etc. in any kind of application area (store, office, social media, education etc.), over the mobile application.

Credit record data, identification number, social media accounts, business card information, e-mail information, telephone number, business card details etc. multi information are available within QR code (datamatrix) which is in the scope of the invention.

Another purpose of the system is to create private QR code (Datamatrix) in the course of card printing and to print QR code (Datamatrix) on plastic card by giving an image as other print images on the same card.

The application is representatively produced as matchless for plastic cards which are functioned as payment and communication instrument and datamatrix is used only for once. Datamatrix produced may be read through a handheld terminal as well as it may be read by a barcode scanner or a mobile application that is improved for mobile phones and thus information is accessed.

The invention is a system enabling operators, by also integrating with sale systems of operators, to reward their customers in line with amount and frequency of shopping of customers, with a handheld terminal. The system includes a central server in which prize gaining/using records and information is available, which is captured by QR code that is read by handheld terminal.

Structural and characteristic features and all advantages of the invention will make better sense thanks to following figures and detailed explanation attributed to these figures and so the evaluation should be made considering these figures and detailed explanations.

### FIGURES FOR UNDERSTANDING OF THE INVENTION

FIG. 1, is a drawing that demonstrates the elements and communication between them.

### EXPLANATION OF ITEM REFERENCES

10. User
20. Plastic card
30. QR code (Datamatrix) on plastic card
40. Application area
50. Handheld terminal (barcode scanner etc.)
60. Central server

### Detailed Explanation of the Invention

In this detailed explanation, preferred structure of the system is explained just for better understanding of the issue.

For the method, usage of QR code (30) on plastic card is aimed. QR code (Datamatrix) (30) is barcode system. That accelerating the flow of information is the basic characteristic of QR code (30). It enables immediate accession to information and thus may record it.

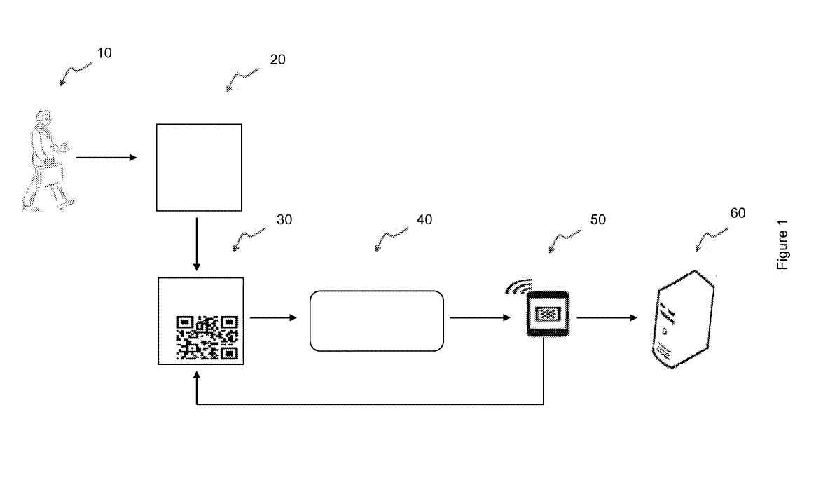

FIG. 1 schematically shows the way accessing multi information within the card thanks to QR code (Datamatrix) (30) applied onto plastic card (20).

QR codes (Datamatrix) (30) are created specific to user (10) in the course of card printing. Credit registry data, identification number, social media accounts, business card information, e-mail information, telephone number, business card details etc. multi information are available within QR code (Datamatrix) (30).

QR codes (Datamatrix) (30) contain data of a single TCKN and card number specific to user (10) and date of expiry. QR codes (Datamatrix) (30) are created while forming the card (20), these QR codes (Datamatrix) (30) are printed on the card (20).

TCKN of the person, card number, date of expiry, name and surname of the person are available within QR code (Datamatrix) (30). As this QR codes (Datamatrix) (30) is read and password of the card is entered by the card holder, a cloud based application steps in through mobile application or the system integrated to the store, credit score specific to the person is enabled to drop to the telephone of the person reading the QR code (Datamatrix) (30) or integrated system. Additionally, product sale offers and loyalty scores that have been calculated over the cloud are demonstrated to the person making scanning. Person or organization scanning QR code (Datamatrix) (30) may offer alternative sale suggestions to his customer.

When the user (10) comes to application area (40) with this plastic card (20), if he wants to take benefit from campaign/discount or share his credit card with opposite party, such as, store manager may access multi information by scanning the card (20) with a handheld terminal (50) or barcode scanner. There is a central server (60) in which information, retained by QR code (Datamatrix) which is scanned by handheld terminal (50), and prize gaining/using records are kept.

Application area (40) may be store, selling spaces for any kinds of product, education area etc.

The system works by using the following procedure steps respectively:
QR code (Datamatrix) (30) is created in which multi information takes place among those requested,
QR code (Datamatrix) (30) is printed on plastic card (20),
User (10) goes to the application area (40) with plastic card (20),
QR code (Datamatrix) (30) is scanned at application area (40) using handheld terminal, mobile application or barcode scanner (50),
Card holder enters his password,
Information of card holder is seen by 3^{rd} person.

1. Invention is QR (datamatrix) coded multi information system that is developed for user (10) to benefit from campaign/discount at application area (40) and includes;
QR code (Datamatrix) (30) in which desired multi information takes part,
Plastic card (20) on which QR code (Datamatrix) (30) is printed,
Handheld terminal, mobile application or barcode scanner (50) for reading QR code (Datamatrix) (30) at application area (40).

2. That mentioned in Request 1 is QR (datamatrix) coded multi information system and it's characteristic is that QR code (Datamatrix) (30) is integrated with a portable plastic card (20).
